(19) United States
(12) Patent Application Publication
(10) Pub. No.: US 2025/0266020 A1
(43) Pub. Date: Aug. 21, 2025

(54) PERCUSSION INSTRUMENT AND FORMATION METHOD OF HIT SURFACE

(71) Applicant: Roland Corporation, Shizuoka (JP)

(72) Inventor: Syota Kobayashi, Hamamatsu (JP)

(73) Assignee: Roland Corporation, Shizuoka (JP)

(21) Appl. No.: 19/007,558

(22) Filed: Jan. 2, 2025

(30) Foreign Application Priority Data
Feb. 21, 2024 (JP) 2024-024565

(51) Int. Cl. G10D 13/20; G10D 13/02; G10D 13/11; G10D 13/24

(52) U.S. Cl. CPC G10D 13/20; G10D 13/02; G10D 13/11; G10D 13/24

(57) ABSTRACT

Provided are a percussion instrument and a formation method of hit surface. The percussion instrument includes: a first cushion; a membrane-like membrane member joined to a front surface of the first cushion to form a hit surface; and a regulation device configured at a position overlapping with outer edges of the first cushion and the membrane member in a thickness direction of the membrane member. When the membrane member is hit, the regulation device regulates deformation that increases a thickness of an outer edge of the first cushion. The formation method of hit surface in the percussion instrument includes forming a hit surface by a part of the membrane member located on an inner peripheral side of the regulation device.

### CROSS-REFERENCE TO RELATED APPLICATION

This application claims the priority benefit of Japan application serial no. 2024-024565, filed on Feb. 21, 2024. The entirety of the above-mentioned patent application is hereby incorporated by reference herein and made a part of this specification.

### BACKGROUND

### Technical Field

The disclosure relates to a percussion instrument and a formation method of hit surface, and particularly relates to a percussion instrument and a formation method of hit surface that may improve the durability of the hit surface.

### Description of Related Art

For example, Patent Document 1 (International Publication No. WO 2017/038226 (e.g., paragraphs 0066 and 0067, FIG. 5 and FIG. 6)) describes a technology for forming a hit surface by adhering a cushion portion 47 (first cushion) to the rear surface of a hard body 48 (membrane member) such as woven fabric. According to this technology, the impact when hitting the hard body 48 may be absorbed by the cushion portion 47, thereby reducing the hitting sound generated during such hitting.

In the above-mentioned conventional technology, when the hard body 48 is hit, while the central side of the cushion portion 47 is compressed, a deformation occurs on the outer edge side of the cushion portion 47 that increases the thickness thereof. Due to this deformation of the outer edge part of the cushion portion 47, peeling is likely to occur in the adhesive part between the hard body 48 and the cushion portion 47, or cracks are likely to occur on the outer peripheral surface of the cushion portion 47. Thus, there is a problem that the durability of the hit surface is low.

The disclosure provides a percussion instrument and a formation method of hit surface that may improve the durability of the hit surface.

### SUMMARY

The percussion instrument of the disclosure includes a first cushion; a membrane-like membrane member joined to a front surface of the first cushion to form a hit surface; and a regulation device configured at a position overlapping with outer edges of the first cushion and the membrane member in a thickness direction of the membrane member. When the membrane member is hit, the regulation device regulates deformation that increases a thickness of an outer edge of the first cushion.

In a formation method of hit surface in a percussion instrument of the disclosure, the percussion instrument includes a first cushion; a membrane-like membrane member joined to a front surface of the first cushion; and a regulation device configured at a position overlapping with outer edges of the first cushion and the membrane member in a thickness direction of the membrane member. The formation method of hit surface includes forming a hit surface by a part of the membrane member located on an inner peripheral side of the regulation device.

### BRIEF DESCRIPTION OF THE DRAWINGS

FIG. 1 is a perspective view of the percussion instrument according to the first embodiment.

FIG. 2 is a perspective view of the percussion instrument showing the lifter in a disassembled state.

FIG. 3 is a partially enlarged front view of the percussion instrument as viewed in the direction of arrow III in FIG. 1.

FIG. 4 is a partially enlarged cross-sectional view of the percussion instrument along the line IV-IV in FIG. 3.

FIG. 5 is an exploded perspective view of the attachment.

FIG. 6 is an exploded perspective view of the percussion instrument.

FIG. 7 is a partially enlarged cross-sectional view of the percussion instrument.

FIG. 8 is a partially enlarged cross-sectional view of the percussion instrument showing the state where the hit surface of the attachment is hit by the beater from the state shown in FIG. 4.

FIG. 9A is a partially enlarged front view of the percussion instrument according to the second embodiment, and FIG. 9B is a partially enlarged front view of the percussion instrument according to the third embodiment.

FIG. 10 is an exploded perspective view of the percussion instrument according to the fourth embodiment.

FIG. 11 is a partially enlarged cross-sectional view of the percussion instrument.

### DESCRIPTION OF THE EMBODIMENTS

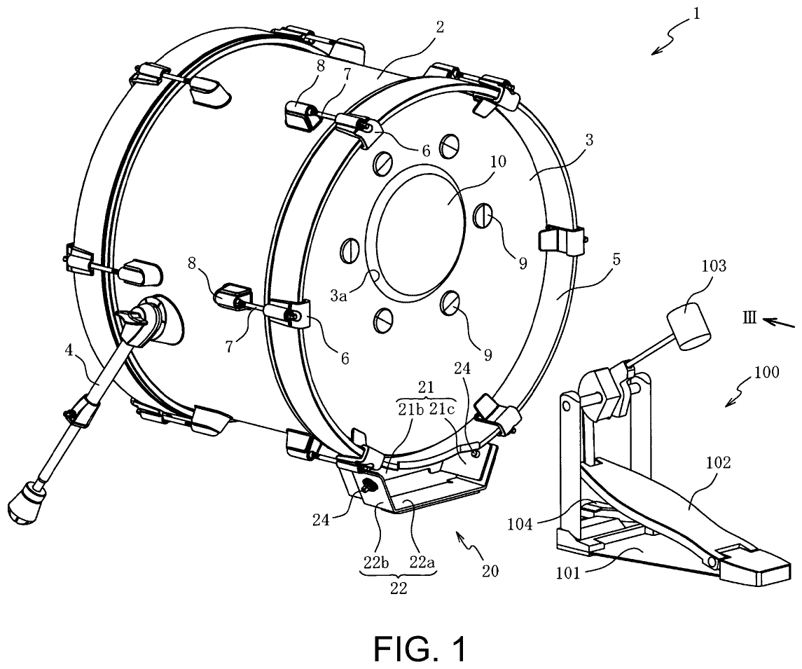

The following describes embodiments with reference to the drawings. First, with reference to FIG. 1, the overall configuration of the percussion instrument 1 according to the first embodiment is described. FIG. 1 is a perspective view of the percussion instrument 1 according to the first embodiment.

It is noted that, in the following description, the side of the percussion instrument 1 closer to the performer when viewed from the performer's side is referred to as the front (front side) of the percussion instrument 1, and the opposite side is referred to as the rear of the percussion instrument 1. Further, the left side when viewed from the performer's side is referred to as the left side of the percussion instrument 1, and the opposite side is referred to as the right side of the percussion instrument 1.

As shown in FIG. 1, the percussion instrument 1 is a bass drum in which the opening part at the front end (axial end portion) of the cylindrical shell 2 is covered with the head 3. A rod-shaped stand 4 that inclines downward toward the rear side of the shell 2 is attached to the outer peripheral surface of the shell 2 (body portion). The stand 4 is provided as a pair on both the left and right side surfaces of the shell 2, and this pair of stands 4 supports the rear end portion of the shell 2 on the installation surface.

The head 3 is formed into a disc shape using a synthetic resin film and is attached to the shell 2 by an annular hoop 5. U-shaped attaching parts 6 are hooked onto the hoop 5 at multiple locations in the circumferential direction. Through holes (not shown) are formed in the parts of the attaching parts 6 located on the outer peripheral side of the hoop 5, and tension bolts 7 are inserted into these through holes. Multiple lugs 8 are provided on the outer peripheral surface of the shell 2, arranged in the circumferential direction, and with the outer edge of the head 3 hooked onto the hoop 5, tension is applied to the head 3 by screwing the tension bolts 7 into the lugs 8.

The attachment 10 is fixed to the head 3 by multiple fixing parts 9. The detailed configuration of this fixing structure using the fixing parts 9 and the attachment 10 is described later, but the attachment 10 is fitted into a circular through hole 3a formed in the head 3, and this attachment 10 is hit by the foot pedal 100.

The foot pedal 100 includes a base plate 101 that is installed on the installation surface, and a foot board 102 is pivotally supported at the base end part (the end on the performer's side) of this base plate 101. When the performer steps on the foot board 102, the beater 103 rotates to hit the attachment 10 (performing the percussion instrument 1). A clamp 104 is provided at the front end side of the base plate 101, and in response to performing the percussion instrument 1, this clamp 104 is attached to the lifter 20 of the percussion instrument 1.

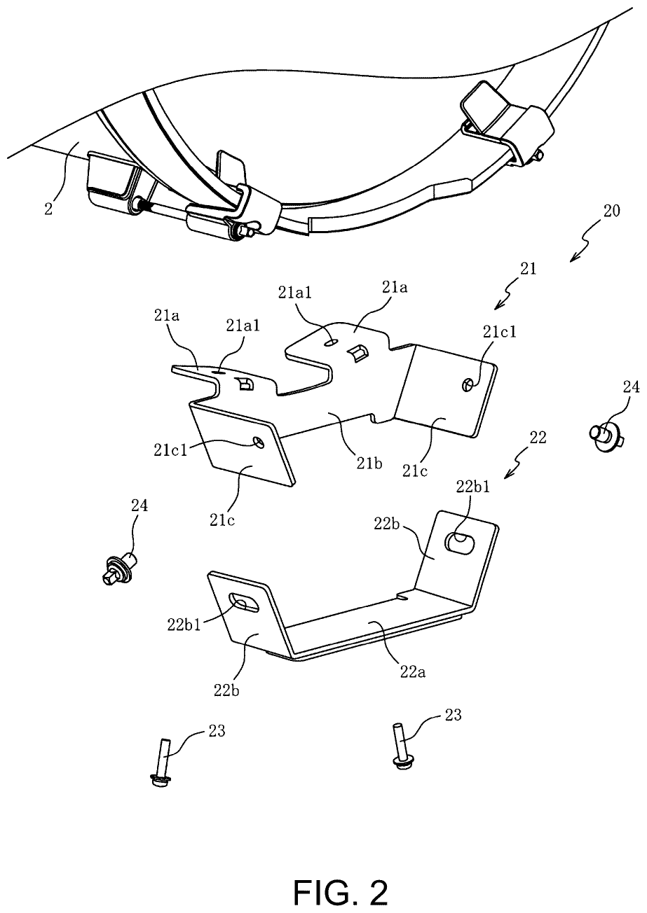

Next, the detailed configuration of the lifter 20 is described with reference to FIG. 1 and FIG. 2. FIG. 2 is a perspective view of the percussion instrument 1 showing the lifter 20 in a disassembled state.

As shown in FIG. 1 and FIG. 2, the lifter 20 includes a fixing member 21 that is fixed to the shell 2, and an attaching member 22 that is attached to the fixing member 21. Each of the fixing member 21 and the attaching member 22 (lifter 20) has a left-right symmetrical shape.

The fixing member 21 includes a pair of fixing portions 21a (refer to FIG. 2) spaced apart in the left and right direction (circumferential direction of the outer peripheral surface of the shell 2). The fixing portion 21a is formed in a rectangular flat plate shape, and a through hole 21a1 is formed in the center of the fixing portion 21a. The fixing member 21 (a pair of fixing portions 21a) is attached to the shell 2 by fastening bolts 23 inserted into the through holes 21a1 to the shell 2. It is noted that although not shown in the figure, a resin spacer is sandwiched between the fixing portion 21a and the outer peripheral surface of the shell 2.

From the front end side (the end portion on the performer's side) of the pair of fixing portions 21a, hanging portion 21b hang downward, and from both left and right ends of the hanging portions 21b, bent portions 21c are bent toward the front side. Female screw holes 21c1 are formed on the front end side (more toward the front side than the center in the front and rear direction) of the bent portions 21c, and the attaching member 22 is attached to the fixing member 21 by bolts 24 fastened to these female screw holes 21c1 (refer to FIG. 1 for this attached state).

The attaching member 22 includes an attaching portion 22a extending in the horizontal direction, and a pair of fastening portions 22b bent upward from both left and right ends of the attaching portion 22a. Elongated holes 22b1 (refer to FIG. 2) extending in the front and rear direction are formed in the fastening portions 22b, and the attaching member 22 is fixed to the fixing member 21 by fastening bolts 24 inserted into these elongated holes 22b1 to the female screw holes 21c1 of the fixing member 21. On the other hand, in a state where the bolts 24 are loosened, the fastening position of the fastening portions 22b relative to the bent portions 21c may be adjusted in the front and rear direction by sliding the fastening portions 22b (attaching member 22) along the elongated holes 22b1.

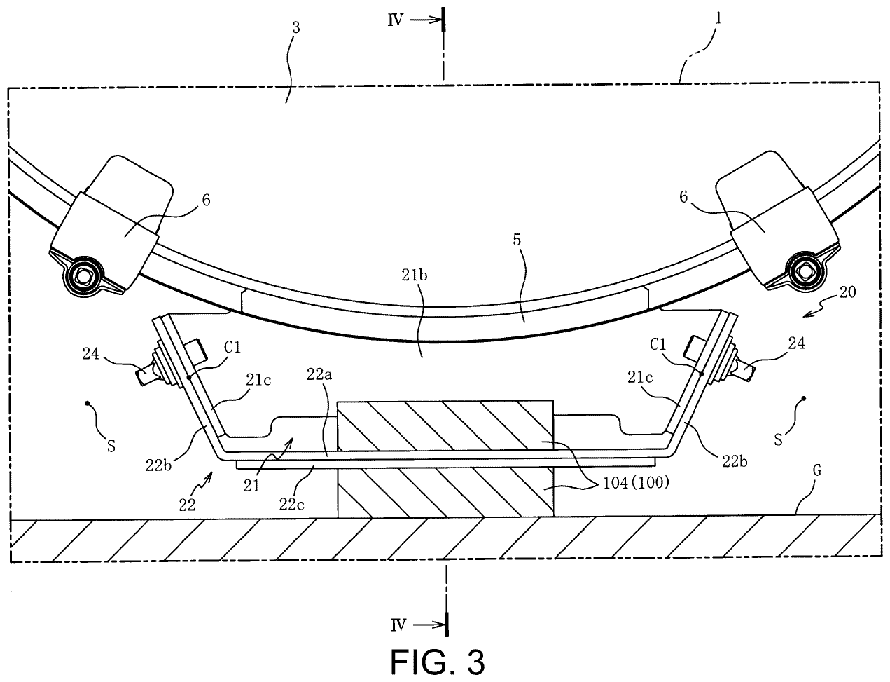

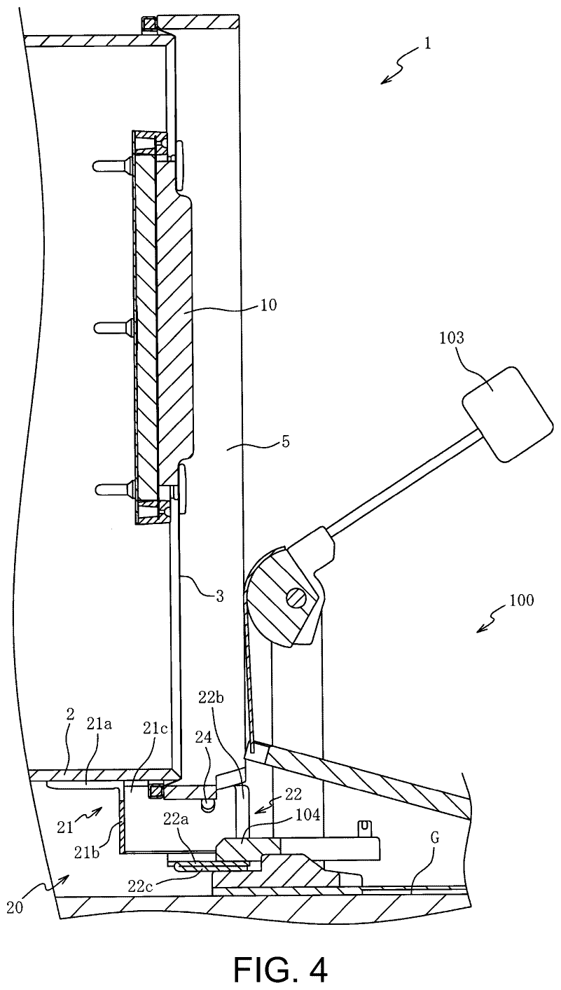

Next, the case where the foot pedal 100 is attached to the lifter 20 is described with reference to FIG. 3 and FIG. 4. FIG. 3 is a partially enlarged front view of the percussion instrument 1 as viewed in the direction of arrow III in FIG. 1, and FIG. 4 is a partially enlarged cross-sectional view of the percussion instrument 1 along the line IV-IV in FIG. 3.

It is noted that in FIG. 3, the shape of the clamp 104 of the foot pedal 100 that grips the attaching member 22 (attaching portion 22a) is schematically illustrated and shown with hatching. Further, in FIG. 4, the illustration of the attaching parts 6 (refer to FIG. 3) of the hoop 5 is omitted.

As shown in FIG. 3 and FIG. 4, in the case of attaching the foot pedal 100 to the percussion instrument 1, the attaching portion 22a is sandwiched from above and below by the clamp 104. In the state where the foot pedal 100 is attached to the attaching portion 22a, the front end portion of the percussion instrument 1 is supported on an installation surface G such as a floor through the foot pedal 100. It is noted that as mentioned above, the rear end side of the percussion instrument 1 is supported on the installation surface G by the stand 4 (refer to FIG. 1).

In response to attaching the foot pedal 100 to the attaching portion 22a, there may be cases where the foot pedal 100 interferes with the percussion instrument 1 (head 3 or hoop 5), or the hitting position of the beater 103 (refer to FIG. 4) is not appropriate. In such cases, an operation is performed to adjust the relative position between the percussion instrument 1 and the foot pedal 100 in the front and rear direction by loosening the bolts 24 and sliding the fastening portions 22b back and forth relative to the bent portions 21c.

As a conventional technology for this type of percussion instrument 1, a technique of fastening bolts from the lower surface side of an attaching member to which a foot pedal is attached (for example, the drum connecting member 23 in Japanese Patent Application Laid-Open Publication No. 2014-071196) is known. However, in this conventional technology, in response to performing the bolt fastening operation, it is necessary to insert a hand (or tool) into the narrow space between the installation surface and the lifter, or to invert the percussion instrument upside down. Thus, adjusting the relative position between the percussion instrument and the foot pedal requires considerable effort.

In contrast, in this embodiment, fastening portions 22b are provided on two sides in the left and right direction of the attaching portion 22a to which the foot pedal 100 is attached, and these fastening portions 22b are fastened to the fixing member 21 (bent portion 21c) by bolts 24. As a result, even in the state where the percussion instrument 1 is installed on the installation surface G, the fastening operation of the bolts 24 may be performed utilizing the relatively wide spaces S (refer to FIG. 3) formed on both left and right sides of the attaching portion 22a (lateral side of the lifter 20). In other words, the relative position between the percussion instrument 1 and the foot pedal 100 may be easily adjusted without inverting the percussion instrument 1 upside down.

In the state where the fixing member 21 and the attaching member 22 are fastened by the bolts 24, the side surface of the bent portion 21c facing the outer side in the left and right direction contacts the side surface of the fastening portion 22b facing the inner side in the left and right direction. Hereinafter, each of these side surfaces are referred to as a “fastening surface”, and the fastening surface of the bent portion 21c and the fastening portion 22b on the left side of the lifter 20 and the fastening surface of the bent portion 21c and the fastening portion 22b on the right side are collectively referred to as the “left and right fastening surfaces”, etc.

In this embodiment, the left and right fastening surfaces are inclined with respect to the vertical direction, but, for example, even if the left and right fastening surfaces are planes along the vertical direction, it is possible to perform the fastening operation of the bolts 24 utilizing the wide spaces S on the left and right sides of the lifter 20 (refer to FIG. 3).

However, in a configuration where the left and right fastening surfaces of the lifter 20 are planes along the vertical direction (the left and right fastening surfaces face each other in parallel), the center axes of the left and right bolts 24 align (line up in a straight line). As a result, the attaching member 22 may rotate around the bolts 24 due to vibrations generated in response to stepping on the foot pedal 100.

In the case where the attaching member 22 rotates around the bolts 24 as an axis, the relative position between the percussion instrument 1 and the foot pedal 100 may shift during performance, resulting in a decrease in the playability of the percussion instrument 1. Further, in response to the attaching member 22 rotating around the bolts 24 as an axis, loosening of the bolts 24 may occur, making it easier for the attaching member 22 to rattle relative to the fixing member 21. This also leads to a decrease in the playability of the percussion instrument 1.

To suppress such rotation of the attaching member 22, it may be considered to fasten each of the left and right fastening surfaces with two bolts 24 (providing a total of four bolts 24 on the left and right fastening surfaces). However, in a configuration where multiple bolts 24 are provided on the left and right fastening surfaces, the fastening operation of the bolts 24 becomes time-consuming, and the lifter 20 becomes larger in size.

In contrast, in this embodiment, the left and right fastening surfaces of the lifter 20 are non-parallel to the vertical direction, and the left and right bolts 24 fasten the fastening portion 22b at positions where their center axes do not align. In other words, it is a configuration where the center axes of the bolts 24, provided one each on the left and right fastening surfaces, do not line up in a straight line.

As a result, the rotation of the attaching member 22 relative to the fixing member 21 (rotation of the attaching member 22 around the bolts 24 as an axis) may be regulated by the engagement between the bolts 24 and the fastening portion 22b, or by the engagement between the left and right fastening surfaces (the bent portion 21c and the fastening portion 22b). Thus, the relative position between the percussion instrument 1 and the foot pedal 100 may be prevented from shifting during performance, thus improving the playability of the percussion instrument 1.

Further, since the attaching member 22 does not rotate around the bolts 24 as an axis, it is possible to suppress the loosening of the bolts 24 due to such rotation. Thus, as it becomes difficult for the attaching member 22 to rattle relative to the fixing member 21 (bent portion 21c), the playability of the percussion instrument 1 may be improved.

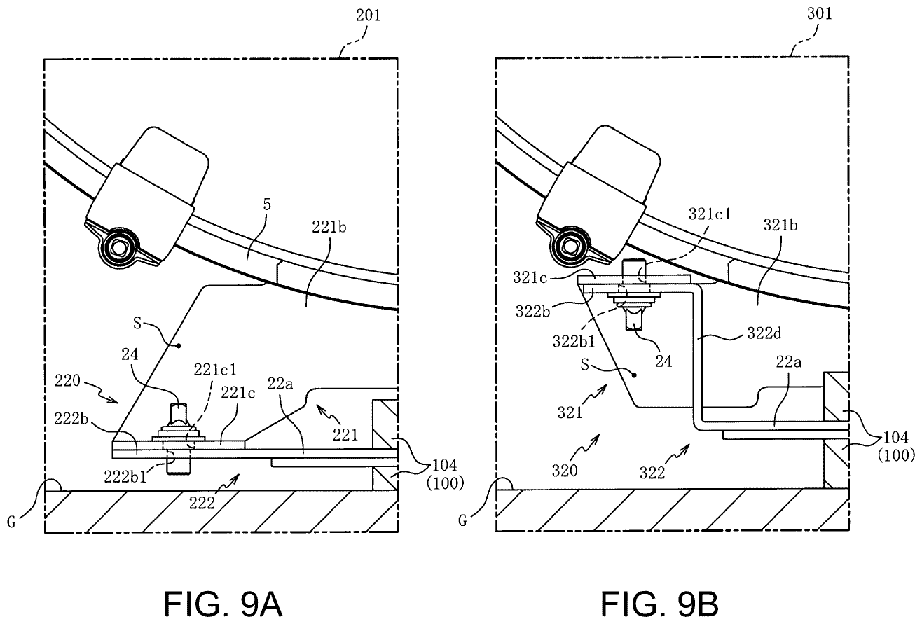

Here, as alternative examples of configurations that may facilitate the fastening operation of the bolts 24, the percussion instruments 201 and 301 of the second and third embodiments to be described later (refer to FIG. 9A and 9B) are illustrated. Details are described later, but in the percussion instrument 201 of the second embodiment (refer to FIG. 9A), the fastening operation of the bolts 24 is performed utilizing the space S between the hoop 5 and the bent portion 221c, and in the percussion instrument 301 of the third embodiment (refer to FIG. 9B), the fastening operation of the bolts 24 is performed utilizing the space S between the fastening portion 322b and the installation surface G.

However, in configurations where the bolts 24 are fastened in the up and down direction, as in the percussion instruments 201 and 301 of the second and third embodiments, the hoop 5 or the installation surface G may interfere with the hand or tool performing the fastening operation of the bolts 24.

In contrast, in this embodiment, since the left and right fastening surfaces (fastening portion 22b) of the lifter 20 are inclined upward from the attaching portion 22a towards the left and right direction outer side (refer to FIG. 3), the bolts 24 may be fastened from the lateral side of the fastening portion 22b. As a result, compared to the percussion instruments 201 and 301 of the second and third embodiments, it becomes less likely for the hoop 5 or the installation surface G to interfere with the hand or tool performing the fastening operation of the bolts 24. Thus, the workability of the fastening operation of the bolts 24 may be improved.

Further, the axis of the bolts 24 is positioned above the up and down direction center C1 of the left and right fastening surfaces. In other words, since the bolts 24 fasten the fixing member 21 (bent portion 21c) and the fastening portion 22b at a position above the up and down direction center C1 of the fastening surfaces, compared to a case where the bolts 24 are provided below the up and down direction center C1 of the fastening surfaces, it becomes less likely for the installation surface to interfere with the hand or tool performing the fastening operation of the bolts 24. This also contributes to improving the workability of the fastening operation of the bolts 24.

It is noted that in this embodiment, the inclination angle of the left and right fastening surfaces (bent portion 21c and fastening portion 22b) with respect to the vertical direction is 25°, but it is preferable that this inclination angle of the fastening surfaces is between 5° and 40°. Within this range of angles, interference of the percussion instrument 1 or the installation surface with the hand or tool performing the fastening operation of the bolts 24 may be suppressed. Further, it is more preferable that the inclination angle of the left and right fastening surfaces is between 15° and 30°. Within this range of angles, interference of the percussion instrument 1 or the installation surface with the hand or tool performing the fastening operation of the bolts 24 may be suppressed more effectively.

After fastening the fixing member 21 and the attaching member 22 with the bolts 24, the performance of the percussion instrument 1 is carried out by stepping on the foot pedal 100, but during this performance, the attaching portion 22a to which the foot pedal 100 is attached is prone to experiencing loads (vibrations) in the up and down direction. When these loads during performance repeatedly act on the attaching portion 22a, the bolts 24 may become loose.

In other words, as described above, although the lifter 20 of this embodiment is configured to generally prevent the rotation of the attaching member 22 around the axis of the bolts 24, when the loads during performance repeatedly act on the attaching portion 22a (attaching member 22), the bolts 24 may gradually become loose.

In response to this, in this embodiment, the bent portion 21c (fixing member 21) is fastened to the inner side in the left and right direction of the fastening portion 22b. Thus, even if loosening or detachment of the bolts 24 occurs, the bent portion 21c (fixing member 21) may be retained on the inner side of the left and right fastening portions 22b. In other words, even if detachment of the bolts 24 occurs during performance, the state in which the fixing member 21 is supported from below by the attaching member 22 may be maintained, allowing the performance of the percussion instrument 1 to continue.

Further, since the loads during performance are likely to act on the attaching portion 22a, in this embodiment, the rigidity of the attaching portion 22a is ensured by overlapping (joining) the reinforcement portion 22c on the lower surface of the attaching portion 22a. The attaching portion 22a and the reinforcement portion 22c are integrally formed by bending one metal plate (as shown in FIG. 4, the reinforcement portion 22c is folded back from the rear end portion of the attaching portion 22a to the lower surface side of the attaching portion 22a). Similarly, the attaching portion 22a and the fastening portion 22b are also integrally formed by bending a metal plate, so that the attaching member 22 including these portions 22a to 22c may be easily formed from one metal plate.

Further, the loads during performance also act on the fixing member 21 through the attaching member 22. In this case, as in the percussion instruments 201 and 301 of the second and third embodiments to be described later (refer to FIG. 9A and 9B), in the case where the structure is such that the bent portions 221c and 321c are bent from the lower end portion or upper end portion of the hanging portions 221b and 321b, the load from stepping on the foot pedal 100 acts in the plate thickness direction of the bent portions 221c and 321c. As a result, deflection is likely to occur in the bent portions 221c and 321c, or bending is likely to occur in the bending parts between the hanging portions 221b and 321b and the bent portions 221c and 321c.

In other words, in the configurations of the second and third embodiments to be described later, the rigidity of the fixing members 221 and 321 against the loads acting from the foot pedal 100 decreases, making it easier for the relative position between the percussion instrument 1 and the foot pedal 100 to shift during performance.

In response to this, in this embodiment, since the fastening portions 22b are fastened to the bent portions 21c that bend forward from both left and right ends of the hanging portion 21b (the plate surfaces of the bent portions 21c are directed left and right), it is possible to suppress the up and down direction loads during performance from acting in the plate thickness direction (the bending direction of the bent portions 21c relative to the hanging portion 21b) of the bent portions 21c. This may suppress the occurrence of bending in the bent portions 21c or deformation in the bending parts between the hanging portion 21b and the bent portions 21c. In other words, the rigidity of the fixing member 21 against the loads acting from the foot pedal 100 may be improved, making it difficult for the relative position between the percussion instrument 1 and the foot pedal 100 to change during performance. As a result, the playability of the percussion instrument 1 may be improved.

Further, since the fixing portions 21a, hanging portion 21b, and bent portions 21c constituting the fixing member 21 are integrally formed by bending a metal plate, the fixing member 21 may be easily formed from one metal plate.

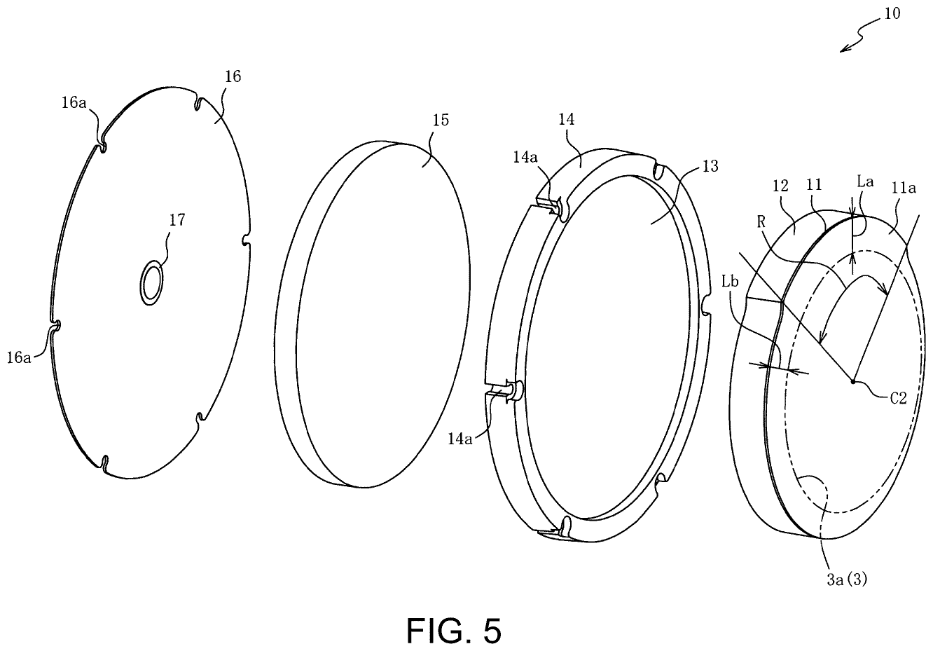

Next, referring to FIG. 5, the configuration of the attachment 10 that is hit by the beater 103 (refer to FIG. 4) during performance of the percussion instrument 1 is described. FIG. 5 is an exploded perspective view of the attachment 10.

As shown in FIG. 5, the attachment 10 includes a disc-shaped membrane member 11 whose front surface serves as a hit surface 11a, and a cushion 12 is adhered to the rear surface of the membrane member 11 to absorb the impact of hits on the hit surface 11a.

The membrane member 11 is formed into a membrane shape using a mesh material made by weaving synthetic fibers, but the material of the membrane member 11 may be any material that is harder (has a higher hardness) than the cushion 12. Thus, for example, the membrane member 11 may be formed using a synthetic resin film. The cushion 12 is formed into a disc shape thicker than the membrane member 11, and the diameters of the membrane member 11 and the cushion 12 are the same. In other words, the outer shapes (shapes in the front and rear direction view) of the membrane member 11 and the cushion 12 are identical to each other.

The cushion 12 is formed using polyurethane foam, which is a foamed synthetic resin. However, the cushion 12 may be formed using a resin such as rubber or elastomer (synthetic resin), or a foam material using such a resin (hereinafter referred to as an “elastic material”) as long as it has a predetermined degree of flexibility.

The rear surface of the cushion 12 is supported by a supporting membrane 13. The supporting membrane 13 is formed into a disc shape using a mesh of woven synthetic fibers or a synthetic resin film, and an annular frame 14 is fixed to the outer edge of the supporting membrane 13. The frame 14 is formed using a resin material, and the supporting membrane 13 and the frame 14 are integrally formed by mold forming. Alternatively, the frame 14 may be formed using a material other than resin (for example, metals such as aluminum or iron) and joined to the supporting membrane 13 by adhesion or other means.

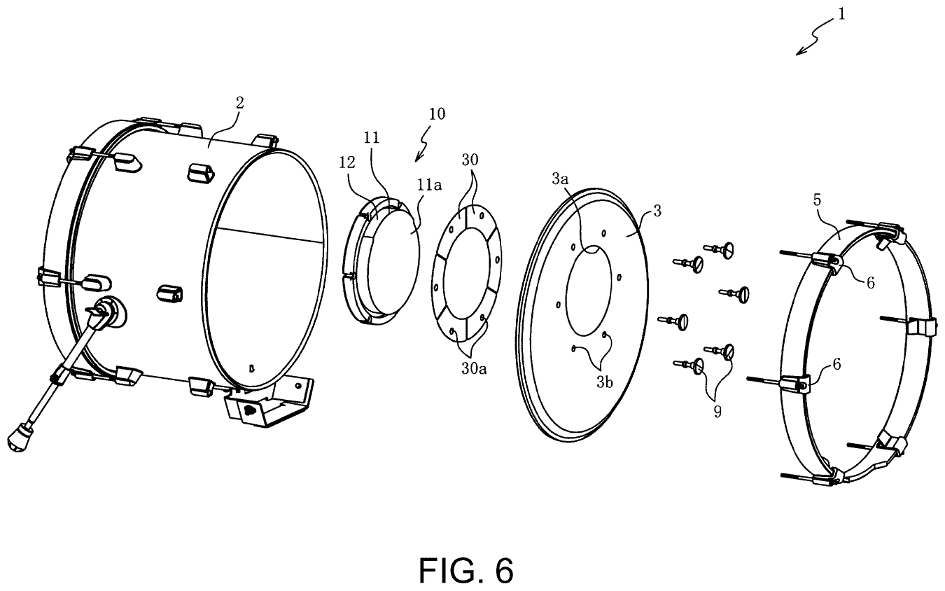

Multiple (in this embodiment, six) press-fit holes 14a are formed at equal intervals in the circumferential direction on the outer edge of the frame 14. These press-fit holes 14a are holes into which the fixing parts 9 (refer to FIG. 6) described later are fitted.

A disc-shaped cushion 15 formed using an elastic material is stacked on the rear surface of the supporting membrane 13, and an attaching plate 16 is stacked on the rear surface of the cushion 15. The attaching plate 16 is formed into a disc shape using resin or metal material, and a disc-shaped sensor 17 (piezoelectric element) is attached to the center of the attaching plate 16 using double-sided tape with cushioning properties.

Multiple press-fit holes 16a are formed on the outer edge of the attaching plate 16 in positions corresponding to the press-fit holes 14a of the frame 14. The attachment 10 is attached to the head 3 by the fixing parts 9 (refer to FIG. 6) that are press-fitted into these press-fit holes 14a and 16a.

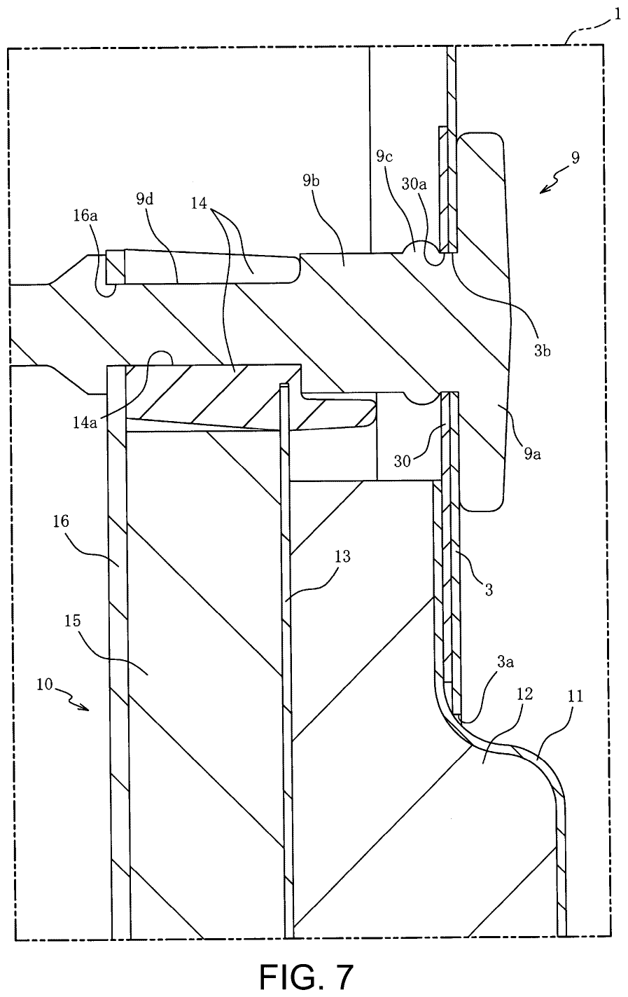

The attachment structure of this attachment 10 is described with reference to FIG. 6 and FIG. 7. FIG. 6 is an exploded perspective view of the percussion instrument 1, and FIG. 7 is a partially enlarged cross-sectional view of the percussion instrument 1. It is noted that in FIG. 7, a cross-section cut along a plane including the axis of the fixing parts 9 is illustrated.

As shown in FIG. 6, the head 3 of the percussion instrument 1 is attached to the shell 2 by the hoop 5 and the attaching parts 6 as described above, and a through hole 3a is formed in the head 3 for fitting the membrane member 11 and the cushion 12 of the attachment 10.

Multiple (in this embodiment, six) press-fit holes 3b are formed at equal intervals in the circumferential direction around the through hole 3a, and the fixing parts 9 are press-fitted into these press-fit holes 3b. The fixing parts 9 are pins made of elastomer or rubber.

Further, multiple (in this embodiment, six) plates 30 made of resin are joined to the rear surface of the head 3 to reinforce the area around the through hole 3a. The multiple plates 30 are formed by equally dividing an annular film in the circumferential direction. In other words, each of the multiple plates 30 is formed into a sector shape, and the through hole 3a is surrounded entirely by these multiple sector-shaped plates 30. Press-fit holes 30a are formed in the plates 30 for press-fitting the fixing parts 9.

As shown in FIG. 7, the fixing parts 9 include a disc-shaped head portion 9a and a shaft portion 9b protruding in the thickness direction (toward the rear side) of the head portion 9a. The diameter of the head portion 9a is formed larger than the diameter of the press-fit hole 3b of the head 3.

The shaft portion 9b is formed with a protrusion 9c for hooking the head 3 and the plate 30, and a groove 9d for hooking the press-fit holes 14a and 16a of the frame 14 and the attaching plate 16. The protrusion 9c is an annular protrusion extending in the circumferential direction of the shaft portion 9b. An interval corresponding to the membrane thickness of the head 3 and the plate 30 is formed between the head portion 9a and the protrusion 9c, and the outer diameter of the protrusion 9c is formed slightly larger than the diameter of the press-fit holes 3b and 30a of the head 3 and the plate 30. Thus, by press-fitting the protrusion 9c into the press-fit holes 3b and 30a, the head 3 and the plate 30 are hooked between the head portion 9a and the protrusion 9c.

The groove 9d is an annular recess extending in the circumferential direction of the shaft portion 9b, and in the region where the groove 9d is formed, the diameter of the shaft portion 9b is formed to be the same as the inner diameter of the press-fit holes 14a and 16a of the frame 14 and the attaching plate 16. Thus, by press-fitting the shaft portion 9b into the press-fit holes 14a and 16a, the frame 14 and the attaching plate 16 are hooked into the groove 9d. As a result, the attachment 10 is attached to the rear surface of the head 3 by the fixing parts 9.

In this attached state of the attachment 10, the supporting membrane 13, the frame 14, the cushion 15, and the attaching plate 16 constitute a supporting body that supports the membrane member 11 and the cushion 12 on the rear surface side of the head 3. Then, the membrane member 11 and the cushion 12, which are interposed between this supporting body and the head 3, are pressed against the peripheral edge portion of the through hole 3a of the head 3 via the plate 30. This configuration improves the durability of the membrane member 11 and the cushion 12.

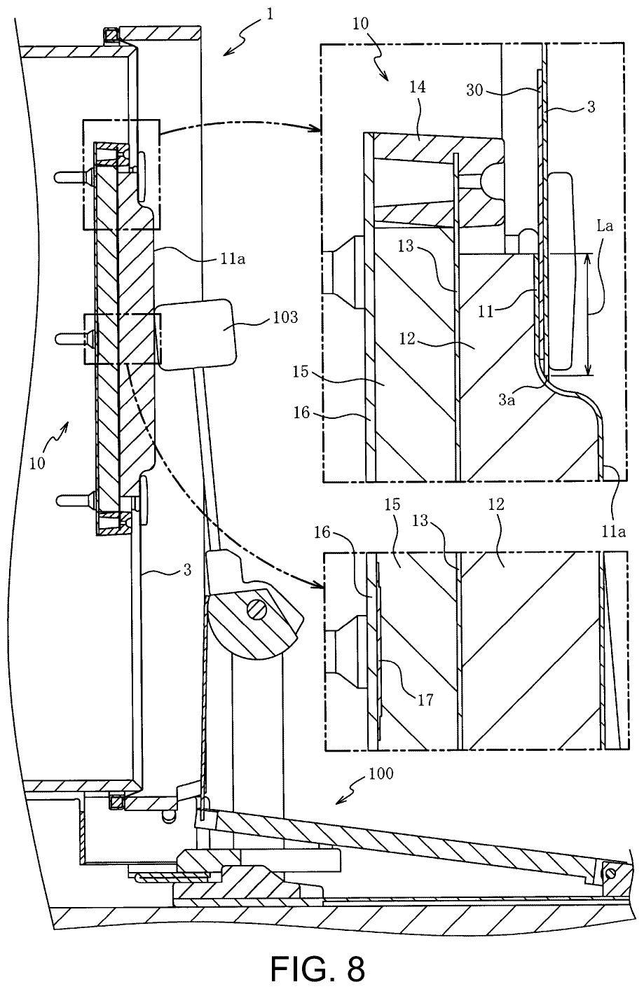

The detailed configuration of this attachment 10 is described with reference to FIG. 8. FIG. 8 is a partially enlarged cross-sectional view of the percussion instrument 1 showing the state where the hit surface 11a of the attachment 10 is hit by the beater 103 from the state shown in FIG. 4.

As shown in FIG. 8, the membrane member 11 (hit surface 11a) of the attachment 10 is hit by the beater 103 of the foot pedal 100, and the impact at the time of this hitting is absorbed by the cushion 12. Thus, the hitting sound generated when the membrane member 11 is hit may be reduced.

In the conventional technology of this type of percussion instrument 1 (for example, International Publication No. 2017/038226), in the case where the membrane member 11 is hit, deformation occurs such that the outer edge part of the cushion 12 expands (increases in thickness). As a result, there were problems such as peeling occurring in the adhesive part between the membrane member 11 and the cushion 12, or cracks occurring on the outer peripheral surface of the cushion 12.

In contrast, in this embodiment, in the front and rear direction, the outer edge parts of the membrane member 11 and cushion 12 are arranged to overlap with the peripheral edge portion of the through hole 3a of the head 3 (the hit surface 11a is formed by the part of the membrane member 11 located on the inner peripheral side of the through hole 3a of the head 3). As a result, in the case where the membrane member 11 is hit by the beater 103, the expansion deformation of the outer edge of the cushion 12 may be regulated by the head 3. Thus, peeling in the adhesive part between the membrane member 11 and cushion 12, or cracks occurring on the outer peripheral surface of the cushion 12 may be suppressed. Thus, the durability of the hit surface 11a (the hit body consisting of the membrane member 11 and the cushion 12) may be improved.

Moreover, in the state where the attachment 10 is attached to the head 3, the interval between the head 3 (plate 30) and the supporting membrane 13 is formed to be smaller than the thickness of the membrane member 11 and the cushion 12. Thus, in the state before the hit surface 11a is hit, the outer edge part of the cushion 12 is compressed by the head 3. This effectively suppresses the expansion deformation of the outer edge part of the cushion 12, thereby improving the durability of the membrane member 11 and the cushion 12.

Further, since the outer edge part of the cushion 12 is compressed by the head 3, the head 3 may be given the function of regulating the expansion of the outer edge of the cushion 12, in addition to the function of attaching the attachment 10.

Further, multiple plates 30 that are harder (have higher hardness) than the head 3 (membrane member 11) are sandwiched between the head 3 and the membrane member 11. These multiple plates 30 are arranged in an annular shape around the through hole 3a, so the expansion deformation of the outer edge of the cushion 12 may be uniformly regulated around the entire circumference of the cushion 12. Thus, the durability of the membrane member 11 and cushion 12 may be improved. Furthermore, the compression amount of the cushion 12 may be adjusted by changing the thickness of the plates 30.

Moreover, since multiple plates 30 are attached around the through hole 3a of the head 3, the rigidity of the head 3 may be increased by the plates 30. This may suppress damage to the head 3 that presses down on the membrane member 11 and the cushion 12, and the expansion deformation of the outer edge of the cushion 12 may be effectively regulated by the head 3 and the plates 30. Thus, the durability of the head 3, the membrane member 11, and the cushion 12 may be improved.

In this way, in the case of aiming to increase the rigidity around the through hole 3a by the plates 30, for example, it is also possible to integrally form multiple plates 30 and attach one annular-shaped plate 30 around the through hole 3a of the head 3. However, in such a configuration, the plate 30 is prone to bending, making it difficult to properly attach the plate 30 to the head 3.

Further, in a configuration where one annular-shaped plate 30 is cut out from a resin plate as the material, the number of plates 30 that may be cut out from the resin plate decreases (all the resin plate cut out from the inner peripheral side of the annular-shaped plate 30 becomes waste material). Thus, the manufacturing cost of the plate 30 increases.

In contrast, in this embodiment, multiple (annular sector) plates 30 are arranged in an annular shape around the through hole 3a. As a result, compared to the case where the plate 30 is formed as one annular shape as described above, the bending of the plates 30 may be suppressed, so the plates 30 may be properly attached to the head 3. Thus, the workability of the attaching operation of the plates 30 may be improved.

Furthermore, when cutting out multiple (annular sector) plates 30 from a resin plate as the material, compared to the case of cutting out one annular-shaped plate 30 as described above, a larger number of plates 30 may be cut out from the resin plate (the amount of resin plate that becomes waste material may be reduced). Thus, the manufacturing cost of the plates 30 may be reduced.

The vibration when the membrane member 11 (hit surface 11a) is hit is detected by the sensor 17 attached to the attaching plate 16, and a musical sound signal based on the detection result is generated by a sound source (not shown). By outputting the musical sound signal generated by the sound source to an amplifier and speaker (both not shown), an electronic musical sound is emitted from the speaker.

In this way, in the case of detecting the hitting of the hit surface 11a with the sensor 17, the conventional technology described above (for example, International Publication No. 2017/038226) has the following problems because there is no member that compresses the outer edge of the cushion 12 as in this embodiment.

Specifically, in a configuration where the outer edge of the cushion 12 is not compressed, compared to the central area of the cushion 12, deformation is more likely to occur (the impact absorption capacity is larger) at the outer edge side of the cushion 12. Thus, in the case where the outer peripheral side of the hit surface 11a (membrane member 11) is hit, the output value of the sensor 17 tends to be smaller compared to the case where the central area of the hit surface 11a is hit. In other words, the sensitivity distribution of the sensor 17 to the hitting of the hit surface 11a becomes non-uniform.

When the sensitivity distribution of the sensor 17 is non-uniform, in the case of hitting the hit surface 11a with a twin-pedal type foot pedal 100, different musical sounds (for example, sounds with different volumes) are likely to be generated when hit by the left and right beaters 103. To resolve such a malfunction in musical sound generation, it is necessary to finely adjust the attaching position of the foot pedal 100 to the percussion instrument 1 in the left and right direction so that the center of the hit surface 11a (sensor 17) is positioned between the left and right beaters 103. Thus, there is a problem that the attaching operation of the foot pedal 100 required extra effort.

In contrast, in this embodiment, because the outer edge of the cushion 12 is compressed, the difference in ease of deformation (impact absorption capacity) between the central area and the outer edge side of the cushion 12 is less likely to occur. This allows for a uniform sensitivity distribution of the sensor 17 to the hitting of the hit surface 11a (membrane member 11). Thus, for example, when using a twin-pedal type foot pedal 100, even if the attaching position of the foot pedal 100 (hitting positions of the left and right beaters 103) is offset to the left or right from the center of the hit surface 11a, appropriate musical sounds are more likely to be generated. In other words, there is no need to finely adjust the attaching position of the foot pedal 100 to the percussion instrument 1 in the left and right direction, thus making the attaching operation of the foot pedal 100 easier.

In this way, in the case of detecting the hitting of the membrane member 11 with the sensor 17 attached to the attaching plate 16, it is possible to omit the cushion 15, for example. In other words, the attachment 10 of this embodiment includes a membrane-like supporting membrane 13 that overlaps the rear surface side of the cushion 12, and a frame 14 connected to the outer edge of the supporting membrane 13, and the attaching plate 16 is attached to this frame 14. Thus, for example, even in the case where the cushion 15 is omitted, the vibration when the membrane member 11 is hit may be transmitted to the sensor 17 through the cushion 12, the supporting membrane 13, the frame 14, and the attaching plate 16.

However, in the case where the cushion 15 is omitted, in the case where the attaching plate 16 itself vibrates due to vibrations transmitted from the frame 14, it is not possible to attenuate the vibration of the attaching plate 16 at an early stage. In the case where the attenuation of the vibration of the attaching plate 16 is slow, there is a possibility that the vibration may be erroneously detected by the sensor 17, making it unable to accurately detect the hitting of the membrane member 11 by the sensor 17.

In contrast, in this embodiment, by having the cushion 15 sandwiched between the supporting membrane 13 and the attaching plate 16, the vibration of the attaching plate 16 may be attenuated at an early stage by the cushion 15. As a result, the hitting of the membrane member 11 may be accurately detected by the sensor 17.

In this way, while the cushion 15 is required to have the function of absorbing the vibration of the attaching plate 16, the cushion 12 needs to have not only the function of absorbing the impact during the hitting of the membrane member 11 but also the function of providing the hitting feel (similar to that of an acoustic drum) during the hitting of the membrane member 11. Thus, in this embodiment, the cushion 12 is formed using a foam material with a higher density (higher hardness) than the cushion 15. As a result, while absorbing the impact during the hitting of the membrane member 11 by the cushion 12, the hitting feel during the hitting of the membrane member 11 may be improved.

On the other hand, since the hitting feel during the hitting of the membrane member 11 may be generally ensured by the cushion 12 and the supporting membrane 13, the cushion 15 is not required to have the function of providing the hitting feel, but mainly only the function of attenuating the vibration of the attaching plate 16. Thus, by forming the cushion 15 from a low-density foam material, it is possible to reduce the cost (and weight) of the cushion 15 while providing the necessary function (attenuating the vibration of the attaching plate 16) to the cushion 15.

Further, because the sensor 17 is sandwiched between the cushion 15 and the attaching plate 16, the sensitivity of the sensor 17 to the hitting of the membrane member 11 may be improved (the maximum value of the sensor 17 output may be increased) compared to the case where the sensor 17 is attached to the rear surface of the attaching plate 16. This is considered to be because a part of the vibration during the hitting of the membrane member 11 is transmitted to the sensor 17 through the cushion 12, the supporting membrane 13, and the cushion 15. As a result, the hitting of the membrane member 11 may be accurately detected by the sensor 17.

In this case, the direction of hitting by the beater 103 is often in a downward inclined direction towards the rear lower side of the percussion instrument 1 (direction towards the lower left in FIG. 8), and when the membrane member 11 is hit in such a direction, the membrane member 11 and the cushion 12 are pushed down (pulled) downward. For this reason, if the overlap amount La between the membrane member 11 and the head 3 on the upper end side is small, the outer edge of the membrane member 11 and the cushion 12 tends to be exposed (protrude) to the inner peripheral side of the through hole 3a of the head 3 during the hitting by the beater 103.

In contrast, this embodiment has a configuration that may suppress such exposure of the membrane member 11 and the cushion 12. This configuration is described with reference back to FIG. 5. It is noted that in FIG. 5, a circle corresponding to the through hole 3a of the head 3 is illustrated by a two-dot chain line.

As shown in FIG. 5, the radial dimension of the membrane member 11 and the cushion 12 with respect to the center C2 of the through hole 3a is formed to be the largest in the region R on the upper end side of the membrane member 11 and the cushion 12. In other words, the overlap amount La between the head 3 and the membrane member 11 (cushion 12) in the region R including the upper edge of the membrane member 11 is formed to be larger than the overlap amount Lb in other regions. These overlap amounts La and Lb indicate the range where the peripheral edge portion of the through hole 3a of the head 3 overlaps with the membrane member 11 and the cushion 12 in the front and rear direction view (thickness direction view of the membrane member 11).

By increasing the overlap amount La with the head 3 in the region R including the upper edge of the membrane member 11 (cushion 12) in this way, even if the membrane member 11 and the cushion 12 are pushed down by the hitting of the beater 103 (refer to FIG. 8), the exposure (protrusion) of the outer edge of the membrane member 11 and the cushion 12 to the inner peripheral side of the through hole 3a may be suppressed. By suppressing such exposure of the membrane member 11 and the cushion 12, interference with the performance of the percussion instrument 1 may be suppressed (for example, the operation of reattaching the attachment 10 to the head 3 may be eliminated).

It is noted that the dimension of the overlap amount La between the head 3 and the membrane member 11 (cushion 12), and the range in the circumferential direction of the region R where the overlap amount La is relatively large, may be appropriately set to the extent that the membrane member 11 and the cushion 12 do not expose to the inner peripheral side of the through hole 3a during the hitting by the beater 103.

Next, with reference to FIG. 9A and 9B, the percussion instruments 201 and 301 of the second and third embodiments are described. In the aforementioned first embodiment, a case where bent portions 21c are formed on both left and right ends of the hanging portion 21b of the lifter 20 is described. In the second and third embodiments, cases where bent portions 221c and 321c are formed on both upper and lower end sides of the hanging portions 221b and 321b are described. It is noted that the same parts as those in the above-mentioned first embodiment are denoted by the same reference numerals, and the description thereof is omitted.

FIG. 9A is a partially enlarged front view of the percussion instrument 201 of the second embodiment, and FIG. 9B is a partially enlarged front view of the percussion instrument 301 of the third embodiment.

As shown in FIG. 9A, the lifter 220 of the percussion instrument 201 of the second embodiment includes a fixing member 221 fixed to the shell 2 (refer to FIG. 1), and an attaching member 222 attached to the fixing member 221. Each of the fixing member 221 and the attaching member 222 (lifter 220) has a left-right symmetrical shape.

The hanging portion 221b of the fixing member 221 has the same configuration as the hanging portion 21b (refer to FIG. 3) of the first embodiment, except that both left and right ends (for example, the left end in FIG. 9A) are extended to incline downward toward the left and right direction outer side.

From the lower end portion of the hanging portion 221b positioned on the left and right direction outer side of the attaching portion 22a, the bent portion 221c is bent toward the front side. An elongated hole 221c1 extending in the front and rear direction is formed in the bent portion 221c, and a bolt 24 is inserted from above into this elongated hole 221c1.

The attaching member 222 has the same configuration as the attaching member 22 (refer to FIG. 3) of the first embodiment, except that both left and right ends of the attaching portion 22a (for example, the left end in FIG. 9A) are extended in the left and right direction outer side to form the fastening portion 222b. A female screw hole 222b1 is formed in the fastening portion 222b, and the attaching member 222 is fixed to the fixing member 221 by fastening the bolt 24 inserted into the elongated hole 221c1 of the fixing member 221 to the female screw hole 222b1.

In this embodiment as well, the fastening portions 222b are provided on two sides in the left and right direction of the attaching portion 22a to which the clamp 104 (foot pedal 100) is attached, and these fastening portions 222b are fastened to the fixing member 221 (bent portion 221c) by the bolts 24. As a result, even in the state where the percussion instrument 201 is installed on the installation surface G, the fastening operation of the bolts 24 may be performed utilizing the relatively wide space S formed on both left and right sides of the attaching portion 22a (between the bent portion 221c and the hoop 5). In other words, the relative position between the percussion instrument 201 and the foot pedal 100 may be easily adjusted without inverting the percussion instrument 201 upside down.

Further, the fastening surfaces between the bent portion 221c and the fastening portion 222b extend in the horizontal direction as flat surfaces, and although not shown in the figure, the left and right pair of bolts 24 fasten the fastening portion 222b at positions where their central axes do not coincide. As a result, even if vibrations from the foot pedal 100 being stepped act on the attaching member 222, rotation of the attaching member 222 around the bolts 24 as an axis may be suppressed. Thus, the relative position between the percussion instrument 201 and the foot pedal 100 may be prevented from shifting during performance, thus improving the playability of the percussion instrument 201. Further, since the attaching member 222 does not rotate around the bolts 24 as an axis, loosening of the bolts 24 may be suppressed. Thus, as it becomes difficult for rattling to occur between the fixing member 221 and the attaching member 222, the playability of the percussion instrument 201 may be improved.

As shown in FIG. 9B, the lifter 320 of the percussion instrument 301 of the third embodiment includes a fixing member 321 fixed to the shell 2 (refer to FIG. 1), and an attaching member 322 attached to the fixing member 321. Each of the fixing member 321 and the attaching member 322 (lifter 320) has a left-right symmetrical shape.

The hanging portion 321b of the fixing member 321 has the same configuration as the hanging portion 21b (refer to FIG. 3) of the first embodiment, except that both left and right ends (for example, the left end in FIG. 9B) are extended in the left and right direction outer side.

From the upper end portion of the hanging portion 321b positioned on the left and right direction outer side of the attaching portion 22a, the bent portion 321c is bent toward the front side. A female screw hole 321c1 is formed in the bent portion 321c, and the bolt 24 is fastened from below to this female screw hole 321c1.

The attaching member 322 has the same configuration as the attaching member 22 (refer to FIG. 3) of the first embodiment, except that it includes bent portions 322d that bend upward from both left and right ends of the attaching portion 22a (for example, the left end in FIG. 9A), and fastening portions 322b that bend in the left and right direction outer side from the upper end of the bent portions 322d.

An elongated hole 322b1 extending in the front and rear direction is formed in the fastening portion 322b, and the attaching member 322 is fixed to the fixing member 321 by fastening the bolt 24 inserted into this elongated hole 322b1 to the female screw hole 321c1 of the fixing member 321.

In this embodiment as well, the fastening portions 322b are provided on two sides in the left and right direction of the attaching portion 22a to which the clamp 104 (foot pedal 100) is attached, and these fastening portions 322b are fastened to the fixing member 321 (bent portion 321c) by the bolts 24. As a result, even in the state where the percussion instrument 301 is installed on the installation surface G, the fastening operation of the bolts 24 may be performed utilizing the relatively wide space S formed on both left and right sides of the attaching portion 22a (between the fastening portion 322b and the installation surface G). In other words, the relative position between the percussion instrument 301 and the foot pedal 100 may be easily adjusted without inverting the percussion instrument 301 upside down.

Further, the fastening surfaces between the bent portion 321c and the fastening portion 322b extend in the horizontal direction as flat surfaces, and although not shown in the figure, the left and right pair of bolts 24 fasten the fastening portion 322b at positions where their central axes do not coincide. As a result, even if vibrations from the foot pedal 100 being stepped act on the attaching member 322, rotation of the attaching member 322 around the bolts 24 as an axis may be suppressed. Thus, the relative position between the percussion instrument 301 and the foot pedal 100 may be prevented from shifting during performance, thus improving the playability of the percussion instrument 301. Further, since the attaching member 322 does not rotate around the bolts 24 as an axis, loosening of the bolts 24 may be suppressed. Thus, as it becomes difficult for rattling to occur between the fixing member 321 and the attaching member 322, the playability of the percussion instrument 301 may be improved.

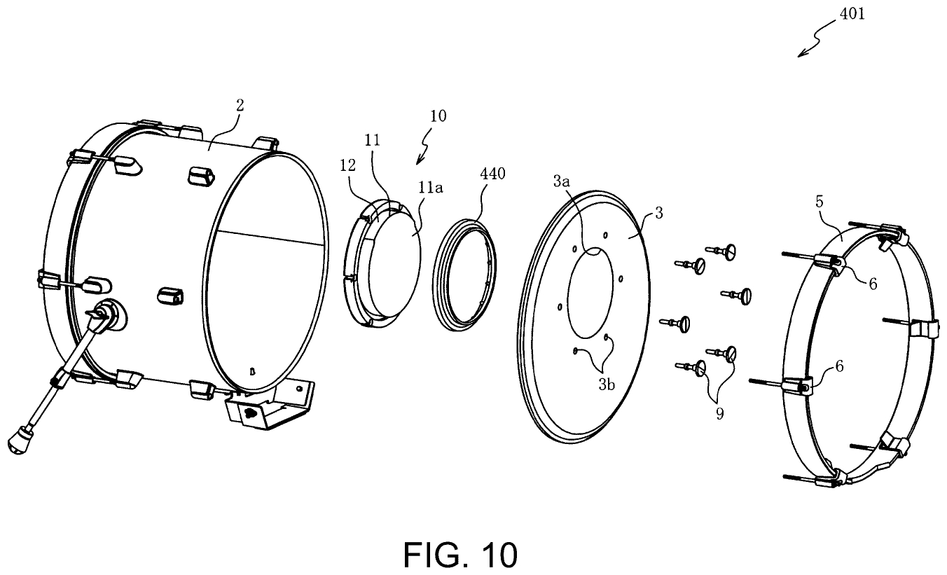

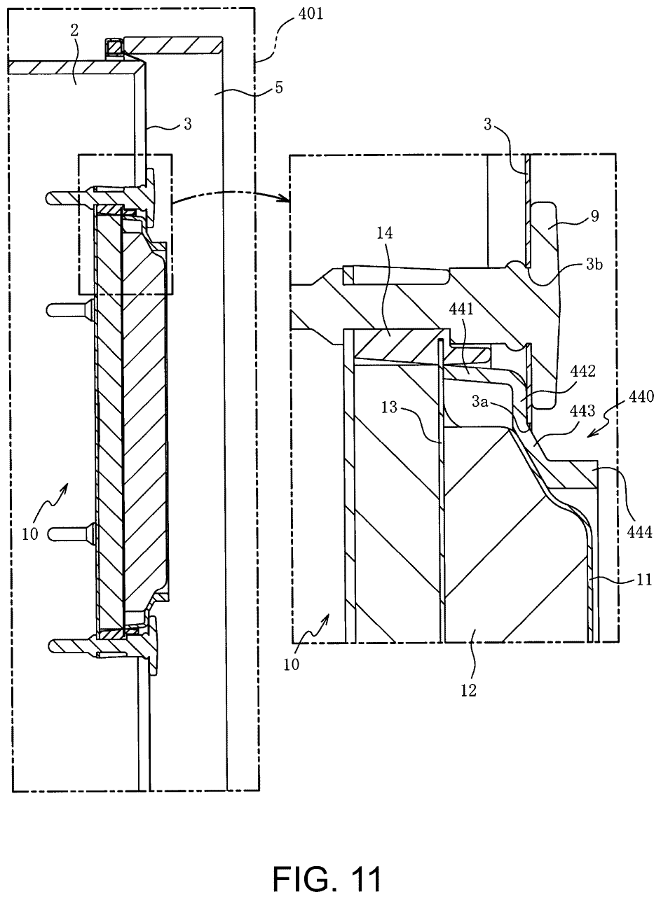

Next, referring to FIG. 10 and FIG. 11, the percussion instrument 401 of the fourth embodiment is described. In the aforementioned first embodiment, a case where the outer edge part of the membrane member 11 and the cushion 12 (hit surface 11a) of the attachment 10 is compressed by the head 3 and the plate 30 is described. In contrast, in the fourth embodiment, a case where the outer edge part of the membrane member 11 and the cushion 12 (hit surface 11a) is compressed by the head 3 and an annular member 440 is described.

FIG. 10 is an exploded perspective view of the percussion instrument 401 according to the fourth embodiment, and FIG. 11 is a partially enlarged cross-sectional view of the percussion instrument 401. It is noted that in FIG. 11, a cross-section cut along a plane including the axis of the fixing parts 9 is illustrated, and the illustration of the attaching parts 6 (refer to FIG. 10) is omitted.

As shown in FIG. 10 and FIG. 11, the percussion instrument 401 of the fourth embodiment has the same configuration as the percussion instrument 1 of the first embodiment, except that an annular member 440 is provided instead of the plate 30 (refer to FIG. 6). Thus, similar to the first embodiment, the head 3 of the percussion instrument 401 is attached to the shell 2 by the hoop 5 and the attaching parts 6, and the attachment 10 is attached to the head 3 by the fixing parts 9 which are press-fitted into the press-fit hole 3b of the head 3.

In the state where the attachment 10 is attached to the head 3, the annular member 440 is sandwiched between the head 3 and the attachment 10. The inner diameter of the annular member 440 is formed to be smaller than the diameter of the through hole 3a of the head 3, while the outer diameter of the annular member 440 is formed to be larger than the diameter of the through hole 3a.

As shown in FIG. 11, the annular member 440 includes an outer peripheral portion 441 that overlaps the front surface of the supporting membrane 13 on the outer peripheral side of the cushion 12. The outer diameter of the outer peripheral portion 441 (annular member 440) is formed to be the same as (or slightly smaller than) the inner diameter of the frame 14. The outer peripheral portion 441 extends forward from the supporting membrane 13 toward the head 3, and from the front end of the outer peripheral portion 441, a bent portion 442 is bent toward the inner peripheral side of the annular member 440. The bent portion 442 is a portion that extends approximately parallel to the head 3, and from the inner edge of the bent portion 442, an inclined portion 443 extends toward the inner peripheral side of the annular member 440.

The inclined portion 443 is inclined away from the supporting membrane 13 toward the inner peripheral side of the annular member 440, and the portion on the inner edge side of the inclined portion 443 protrudes to the front surface side of the head 3 through the through hole 3a. From the inner edge of the inclined portion 443, a protruding portion 444 protrudes toward the front side, and these parts 441 to 444 constituting the annular member 440 are integrally formed using a resin material.

In the state where the attachment 10 is attached to the head 3, the outer edge part of the cushion 12 is compressed by the head 3 and the annular member 440. The annular member 440 is formed annularly using a material harder than the head 3 (membrane member 11), so it may uniformly regulate the expansion deformation of the outer edge of the cushion 12 around its entire circumference. Thus, the durability of the membrane member 11 and cushion 12 may be improved.

Further, the annular member 440 is formed with an inclined portion 443 that is inclined away from the supporting membrane 13 toward its inner peripheral side, and this inclined portion 443 presses down on the outer edge part of the membrane member 11 and the cushion 12. As a result, the compression amount of the cushion 12 by the annular member 440 (inclined portion 443) may be made larger at the outer edge side of the cushion 12 while gradually decreasing toward the inner peripheral side of the cushion 12.

Thus, in the region on the outer edge side of the cushion 12, the expansion deformation of the cushion 12 may be effectively suppressed, while the compression amount of the cushion 12 may be reduced in the area further inward. In the region where the compression amount of the cushion 12 is small, the elastic force of the cushion 12 is less likely to weaken, thus improving the durability of the cushion 12.

The above description has been given based on the above embodiment, but the disclosure is not limited to the above embodiments, and it may be easily inferred that various improvements and modifications are possible within the range that does not deviate from the spirit of the disclosure.

In the above embodiments, the cases where the percussion instruments 1, 201, 301, and 401 include a sensor 17 and are electronic percussion instruments (electronic drums) are described, but the disclosure is not necessarily limited thereto. For example, the percussion instruments 1, 201, 301, and 401 may be percussion instruments that do not include a sensor 17. Further, in the above embodiments, the structure of the lifters 20, 220, and 320 in the percussion instruments 1, 201, 301, and 401 where the attachment 10 is attached to the head 3 is described, but such structure of the lifters 20, 220, and 320 may also be applied to acoustic bass drums.

In the above embodiments, the case where the lifters 20, 220, and 320 (fixing members 21, 221, and 321) are fixed to the outer peripheral surface of the shell 2 is described, but the disclosure is not necessarily limited thereto. For example, the lifters 20, 220, and 320 may be fixed to the hoop 5. In other words, the fixing position of the lifters 20, 220, and 320 relative to the percussion instruments 1, 201, 301, and 401 (housing) may be changed as appropriate.

In the above embodiments, the case where the shape of the lifters 20, 220, and 320 is symmetrical in the left and right direction is described, but the disclosure is not necessarily limited thereto. For example, the shape of the lifters 20, 220, and 320 may be asymmetrical in the left and right direction, and the specific shape of the lifters 20, 220, and 320 is not limited to the above-mentioned forms. In other words, as long as the configuration allows the fastening portions 22b, 222b, and 322b to be provided on both sides of the attaching portion 22a in the left and right direction, and the fastening portions 22b, 222b, and 322b may be fastened at positions where the center axes of the left and right bolts 24 do not coincide, the shape of the lifters 20, 220, and 320 may be changed as appropriate.

In the above embodiments, the case where each part of the fixing members 21, 221, and 321 or the attaching members 22, 222, and 322 is integrally formed by bending a metal plate is described, but a part of the fixing members 21, 221, and 321 or the attaching members 22, 222, and 322 may be formed separately from other parts.

In the above embodiments, the case where the membrane member 11 and the cushion 12 (i.e., the hit body forming the hit surface 11a) are disc-shaped is described, but the disclosure is not necessarily limited thereto. The membrane member 11 and the cushion 12 may be polygonal (for example, rectangular), and in this case, the shape of the through hole 3a of the head 3, the supporting body (such as the supporting membrane 13, frame 14, cushion 15, and attaching plate 16), and the annular member 440 may be formed in a shape corresponding to the membrane member 11 and the cushion 12.

In the above embodiments, the case where the outer edge part of the cushion 12 is compressed by the head 3 (plate 30 and annular member 440) in the state before the hit surface 11a is hit is described, but the disclosure is not necessarily limited thereto. For example, in the state before the hit surface 11a is hit, as long as the configuration is such that the head 3 (plate 30 and annular member 440) is in contact with at least the membrane member 11, the expansion deformation of the outer edge of the cushion 12 may be regulated by the head 3 (plate 30 and annular member 440).

In the above embodiments, the case where the plate 30 or the annular member 440, which is harder than the head 3 (membrane member 11), is provided between the head 3 and the membrane member 11 is described, but the disclosure is not necessarily limited thereto. For example, the plate 30 and the annular member 440 may be omitted, or a configuration using both the plate 30 and the annular member 440 (with the plate 30 interposed between the head 3 and the annular member 440) may be employed. Further, the plate 30 may be attached to the front surface of the head 3.

In the above embodiments, the configuration where the attachment 10 is attached to the head 3, that is, the configuration where the expansion deformation of the outer edge part of the cushion 12 is regulated by the head 3 is described, but the disclosure is not necessarily limited thereto.

For example, a member equivalent to the annular member 440 (one that may hold down the outer edge of the membrane member 11 and the cushion 12) may be attached to the frame 14, or may be integrally formed with the frame 14. In such a configuration, while enabling the use of the attachment 10 itself as a percussion instrument when detached from the head 3 (or the use of the attachment 10 with the sensor 17 removed as a practice pad), the expansion deformation of the outer edge of the cushion 12 may be regulated by the member equivalent to the annular member 440.

In the above embodiments, the case where multiple (annular sector) plates 30 are arranged in an annular shape, or the case where the annular member 440 is formed in an annular shape is described, but the disclosure is not necessarily limited thereto. For example, multiple plates 30 may be integrally formed into one annular-shaped plate 30, or the annular member 440 may be divided into multiple parts in the circumferential direction.

Further, the shape of the multiple plates 30 or the annular member 440 is not limited to an annular shape, and the shape of the plates 30 or the annular member 440 may be appropriately changed as long as it may surround the through hole 3a. Thus, for example, a configuration where one annular plate 30 is formed (or divided into multiple parts) by cutting out the center of a polygonal (e.g., rectangular) resin plate in a circular shape, or a configuration where rectangular plates 30 are arranged in an annular shape, may be employed.

In the above embodiments, the case where the cushion 15 is sandwiched between the supporting membrane 13 and the attaching plate 16, or the case where the sensor 17 is sandwiched between the cushion 15 and the attaching plate 16 is described, but the disclosure is not necessarily limited thereto. For example, the cushion 15 may be omitted, or the sensor 17 may be attached to the rear surface of the attaching plate 16.

In the above embodiments, the case where the cushion 12 is formed using a foam material with a higher density than the cushion 15 is described, but the disclosure is not necessarily limited thereto. For example, the density of cushions 12 and 15 may be the same, or the cushion 12 may be formed using a foam material with a lower density than the cushion 15.

In the above embodiments, the case where the overlap amount La between the head 3 and the region R including the upper edge of the membrane member 11 is formed larger than the overlap amount Lb between the head 3 and other regions is described, but the disclosure is not necessarily limited thereto. For example, the overlap amount La in the region R including the upper edge of the membrane member 11 may be smaller than the overlap amount Lb in other regions, or these overlap amounts La and Lb may be of the same dimension.

In the first embodiment described above, the case where the left and right fastening surfaces of the lifter 20 are fastened by one bolt 24 each is described, but the disclosure is not necessarily limited thereto. For example, the left and right fastening surfaces may be fastened by multiple bolts 24 each.

In the first embodiment described above, the case where the bent portion 21c and the fastening portion 22b are fastened by the bolt 24 on the upper side of the center C1 in the up and down direction of the left and right fastening surfaces of the lifter 20 is described, but the disclosure is not necessarily limited thereto. For example, the bolt 24 may be provided at the center C1 in the up and down direction of the fastening surface or on the lower side thereof.

In the first embodiment described above, the case where the bent portion 21c (fixing member 21) is fastened to the inner side in the left and right direction of the fastening portion 22b is described, but the disclosure is not necessarily limited thereto. For example, the fastening portion 22b (attaching member 22) may be fastened to the inner side in the left and right direction of the bent portion 21c. In this case, by forming the elongated hole 22b1 (refer to FIG. 2) in the bent portion 21c while forming the female screw hole 21c1 (refer to FIG. 2) in the fastening portion 22b, it is possible to fasten the bolt 24 from the lateral side of the bent portion 21c and the fastening portion 22b, while allowing adjustment of the fixed position of the attaching member 22 relative to the fixing member 21 in the front and rear direction.

What is claimed is:

1. A percussion instrument, comprising:
a first cushion; a membrane-like membrane member joined to a front surface of the first cushion to form a hit surface; and a regulation device configured at a position overlapping with outer edges of the first cushion and the membrane member in a thickness direction of the membrane member,
wherein when the membrane member is hit, the regulation device regulates deformation that increases a thickness of an outer edge of the first cushion.

2. The percussion instrument according to claim 1, wherein in a state before the hit surface is hit, an outer edge part of the first cushion is compressed by the regulation device.

3. The percussion instrument according to claim 1, further comprising: a cylindrical body portion; a head covering an opening of the body portion and in which a through hole is formed; and a supporting body attached to a rear surface side of the head and supporting the membrane member and the first cushion in a region where the through hole is formed,
wherein a peripheral edge portion of the through hole of the head is configured as the regulation device.

4. The percussion instrument according to claim 3, further comprising an annular hard body sandwiched between the membrane member and the head, and the hard body being formed harder than the head.

5. The percussion instrument according to claim 4, wherein the hard body is a plate attached to a peripheral edge portion of the through hole of the head.

6. The percussion instrument according to claim 3, wherein the supporting body comprises: a supporting membrane supporting a rear surface of the first cushion; an annular frame connected to an outer edge of the supporting membrane and attached to a rear surface of the head; an attaching plate overlapped on a rear surface side of the frame and to which a sensor is attached; and a second cushion sandwiched between the attaching plate and the supporting membrane.

7. The percussion instrument according to claim 6, wherein the sensor is sandwiched between the attaching plate and the second cushion.

8. The percussion instrument according to claim 6, wherein the first cushion is harder than the second cushion.

9. The percussion instrument according to claim 1, wherein the percussion instrument is a bass drum in which the hit surface is hit by a beater of a foot pedal, and
an overlap amount between the membrane member and the regulation device in a region including an upper edge of the membrane member is formed larger than an overlap amount between the membrane member and the regulation device in other regions.

10. The percussion instrument according to claim 1, wherein a material of the membrane member is harder than the cushion.

11. A formation method of hit surface in a percussion instrument, the percussion instrument comprising: a first cushion; a membrane-like membrane member joined to a front surface of the first cushion; and a regulation device configured at a position overlapping with outer edges of the first cushion and the membrane member in a thickness direction of the membrane member, the formation method of hit surface comprising:
forming a hit surface by a part of the membrane member located on an inner peripheral side of the regulation device.

12. The formation method of hit surface according to claim 11, wherein in a state before the hit surface is hit, an outer edge part of the first cushion is compressed by the regulation device.

13. The formation method of hit surface according to claim 11, further comprising: a cylindrical body portion; a head covering an opening of the body portion and in which a through hole is formed; and a supporting body attached to a rear surface side of the head and supporting the membrane member and the first cushion in a region where the through hole is formed,
wherein a peripheral edge portion of the through hole of the head is configured as the regulation device.

14. The formation method of hit surface according to claim 13, further comprising an annular hard body sandwiched between the membrane member and the head, and the hard body being formed harder than the head.

15. The formation method of hit surface according to claim 14, wherein the hard body is a plate attached to a peripheral edge portion of the through hole of the head.

16. The formation method of hit surface according to claim 13, wherein the supporting body comprises: a supporting membrane supporting a rear surface of the first cushion; an annular frame connected to an outer edge of the supporting membrane and attached to a rear surface of the head; an attaching plate overlapped on a rear surface side of the frame and to which a sensor is attached; and a second cushion sandwiched between the attaching plate and the supporting membrane.

17. The formation method of hit surface according to claim 16, wherein the sensor is sandwiched between the attaching plate and the second cushion.

18. The formation method of hit surface according to claim 16, wherein the first cushion is harder than the second cushion.

19. The formation method of hit surface according to claim 11, wherein the percussion instrument is a bass drum in which the hit surface is hit by a beater of a foot pedal, and
an overlap amount between the membrane member and the regulation device in a region including an upper edge of the membrane member is formed larger than an overlap amount between the membrane member and the regulation device in other regions.

20. The formation method of hit surface according to claim 11, wherein a material of the membrane member is harder than the cushion.
